(19) United States
(12) Patent Application Publication
(10) Pub. No.: US 2004/0145189 A1
(43) Pub. Date: Jul. 29, 2004

(54) Lock assembly with two hook devices

(76) Inventor: Chuen-Yi Liu, Pingtung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/352,432

(22) Filed: Jan. 28, 2003

(51) Int. Cl. E05C 7/00; E05C 9/00

(52) U.S. Cl. 292/24

(57) ABSTRACT

A lock assembly includes a casing, two pivotable members pivotally mounted in the casing and meshed with each other, two linking rods, and two hook devices. Each linking rod has a first end pivotally connected to an associated pivotable member. Each hook device includes a hook member and a rocker arm that is pivotally mounted in the casing. A second end of each linking rod is pivotally connected to an associated rocker arm. Each hook member has a first end pivotally connected to an associated rocker arm and a hooked second end that is passable through an associated one of two openings of the casing. When either pivotable member is pivoted, each rocker arm and each hook member are pivoted such that the hooked second end of each hook member is moved between a retracted position in the casing and an extended position out of the casing.

### BACKGROUND OF THE INVENTION

1. Field of the Invention

The present invention relates to a lock assembly with two hook devices for reliably locking a door.

2. Description of the Related Art

A wide variety of locks have heretofore been provided for different purposes. Typically, a lock includes a single latch bolt for providing the latching function. The latching function provided by the single latch bolt is apt to be destroyed. U.S. patent application Ser. No. 10/298,407 discloses a lock assembly with two hook devices to solve this problem. As illustrated in FIG. 1 of the drawings, the lock assembly disclosed in U.S. patent application Ser. No. 10/298,407 comprises a casing 1 having two openings 14, a pivotable member 11 pivotally mounted in the casing 1, two linking rods 13 respectively provided on two sides of the pivotable member 11, each linking rod 13 including a first end pivotally connected to the pivotable member 11 and a second end, and two hook devices 12 each including a hook member 122 and a rocker arm 121. Each rocker arm 121 is pivotally mounted in the casing. The second end of each linking rod 13 is pivotally connected to an associated rocker arm 121. Each hook member 122 includes a first end 123 pivotally connected to the rocker arm 121 and a hooked second end 124 that is passable through an associated opening of the casing. When the pivotable member 11 is pivoted, each hook member 122 is pivoted such that the hooked second end 124 of each hook member 122 is moved between a retracted position in the casing 1 and an extended position out of the casing 1. However, the casing 1 must include a protruded portion 10 on an inner end thereof for shielding pivotal movement of the inner one of the linking rods 13 (the upper one in FIG. 1). As a result, the mounting hole of a door (e.g., a screen door) in which the lock assembly is mounted must be deepened. Further, the lock assembly cannot be used with doors having various sizes in the mounting hole.

### SUMMARY OF THE INVENTION

An object of the present invention is to provide a dual-hook type lock assembly that has a casing with a reduced thickness, allowing the casing to be conveniently mounted in the mounting hole of the door.

A lock assembly in accordance with the present invention comprises:

a casing having two openings;

two pivotable members pivotally mounted in the casing, the pivotable members being so configured that rotation of one of the pivotable members causes rotation of the other pivotable member;

two linking rods each having a first end pivotally connected to an associated one of the pivotable members and a second end; and

two hook devices each including a hook member and a rocker arm, each said rocker arm being pivotally mounted in the casing, the second end of each said linking rod being pivotally connected to an associated one of the rocker arms, each said hook member having a first end pivotally connected to an associated one of the rocker arms, each said hook member further including a hooked second end that is passable through an associated one of the openings of the casing;

wherein when either of the pivotable members is pivoted, each said rocker arm and each said hook member are pivoted such that the hooked second end of each said hook member is moved between a retracted position in the casing and an extended position out of the casing.

Other objects, advantages, and novel features of the invention will become more apparent from the following detailed description when taken in conjunction with the accompanying drawings.

### BRIEF DESCRIPTION OF THE DRAWINGS

FIG. 1 is a side view of a conventional lock assembly with one casing half being removed to show interior structure.

FIG. 2 is an exploded perspective view of a lock assembly in accordance with the present invention.

FIG. 3 is a side view of the lock assembly with one casing half being removed to show interior structure.

FIG. 4 is a side view similar to FIG. 3, illustrating a transition state of a locking operation of the lock assembly.

FIG. 5 is a side view similar to FIG. 3, wherein the lock assembly is in a locking state.

### DETAILED DESCRIPTION OF THE PREFERRED EMBODIMENT

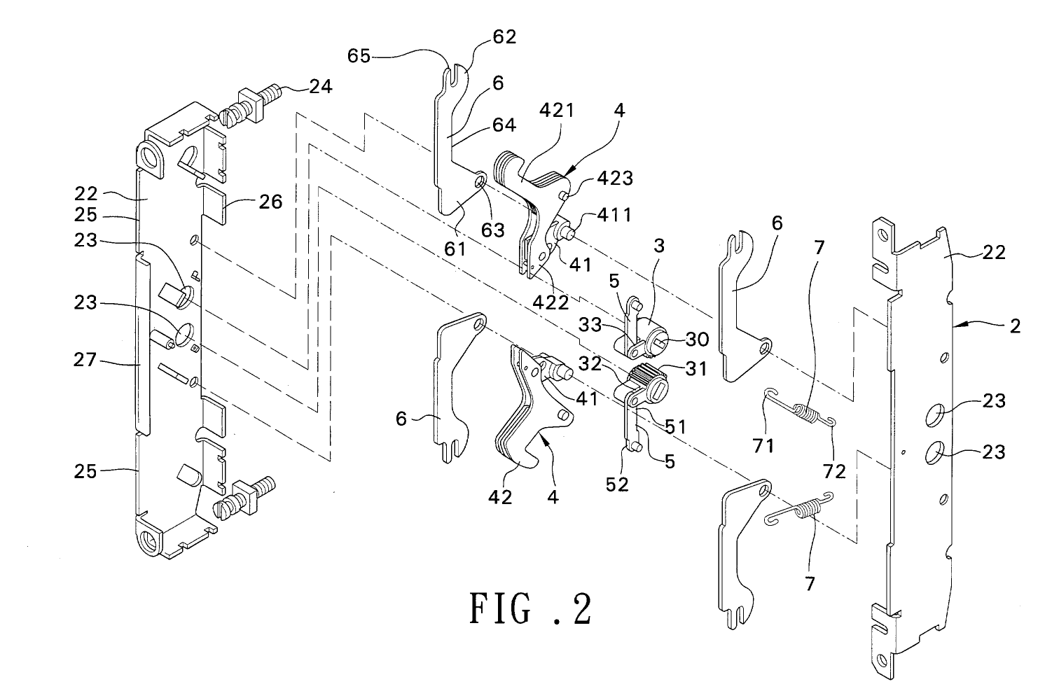

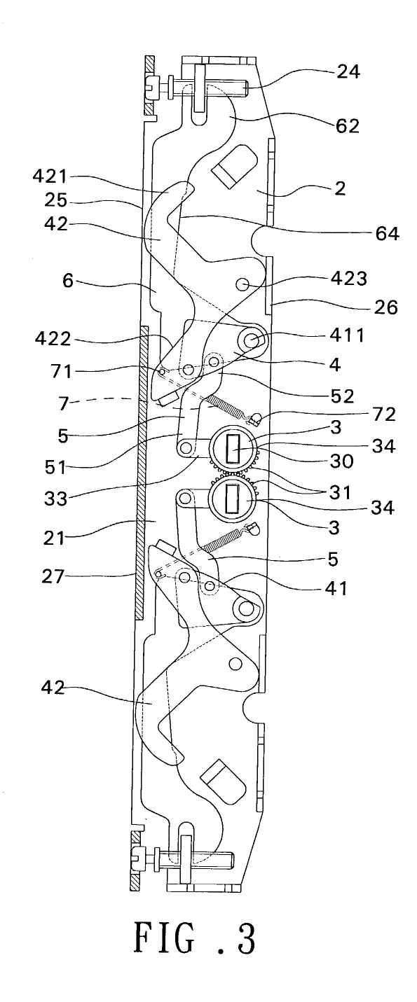

Referring to FIGS. 2 and 3, a lock assembly in accordance with the present invention generally comprises a cashing 2 consisting of two casing halves 22 that together define two openings 25 spaced from each other. Two pivotable members 3 are pivotally mounted in the casing 2. In this embodiment, the pivotable members 3 are pivotally held in aligned holes 23 of the casing halves 22. Each pivotable member 3 includes a toothed portion 31, allowing the pivotal members 3 to mesh with each other such that rotation of either of the pivotal members 3 causes rotation of the other. Each pivotable member 3 further includes a protruded portion or lobe 33 for pivotal connection with a first end 51 of a linking rod 5. Preferably, the lobe 33 of each pivotable member 3 has a slot 33 to allow pivotal movement of the respective linking rod 5.

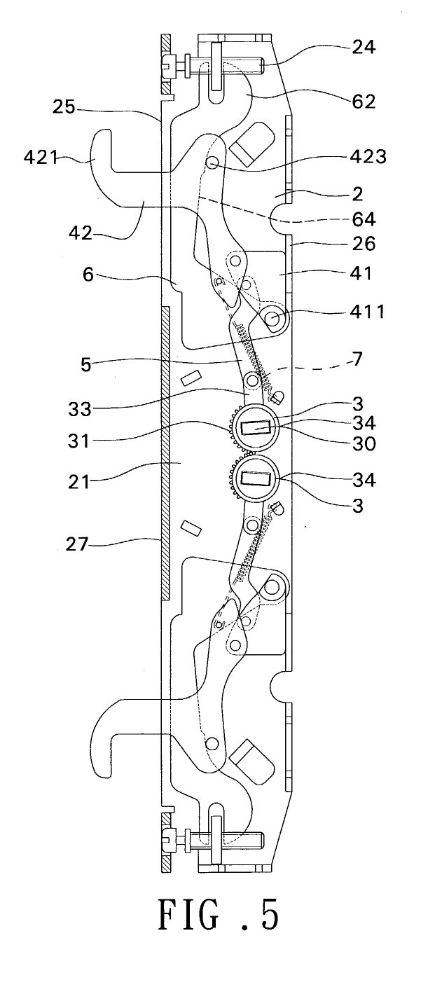

Two hook devices 4 are mounted in the casing 2 and each includes a hook member 42 and a rocker arm 41. The rocker arm 41 includes a stub 411 that is pivotally engaged in aligned holes (not labeled) of the casing halves 22. Each linking rod 5 has a second end 52 that is pivotally connected to an associated rocker arm 41. Each hook member 42 includes a first end 422 that is pivotally connected to an associated rocker arm 41 and a hooked second end 421 that is movable between a retracted position in the casing 2 (FIG. 3) and an extended position outside the casing 2 (FIG. 5). Each hook member 42 further includes a peg 423 on an intermediate portion thereof.

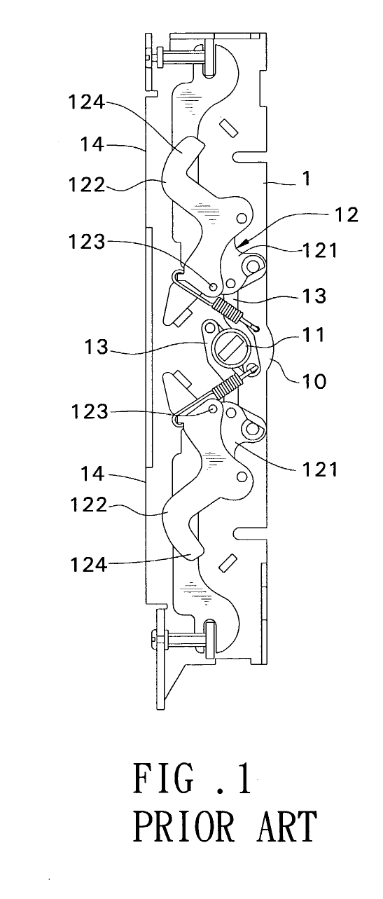

Two springs 7 are provided and each includes a first end 71 attached to an associated hook member 4 and a second end 72 attached to the casing 2. Still referring to FIGS. 1 and 2, the lock assembly in accordance with the present invention further includes two guide plates 6 and two adjusting bolts 24. Each guide plate 6 includes a first end 61 having a hole 63 that is extended through by the stub 411 of the respective rocker arm 41. Thus, the first end 61 of the guide plate 6 is pivotally connected to the stub 411 of the respective rocker arm 41. Each guide plate 6 further includes a second end 62 having a notch 65 for engaging with an associated adjusting bolt 24. When the respective adjusting bolt 24 is turned, the respective guide plate 6 pivots to thereby adjust the angular position of the hooked second end 421 of the respective hook member 42, thereby adjusting the extended length of the respective hook member 42, which is conventional and therefore not described in detail.

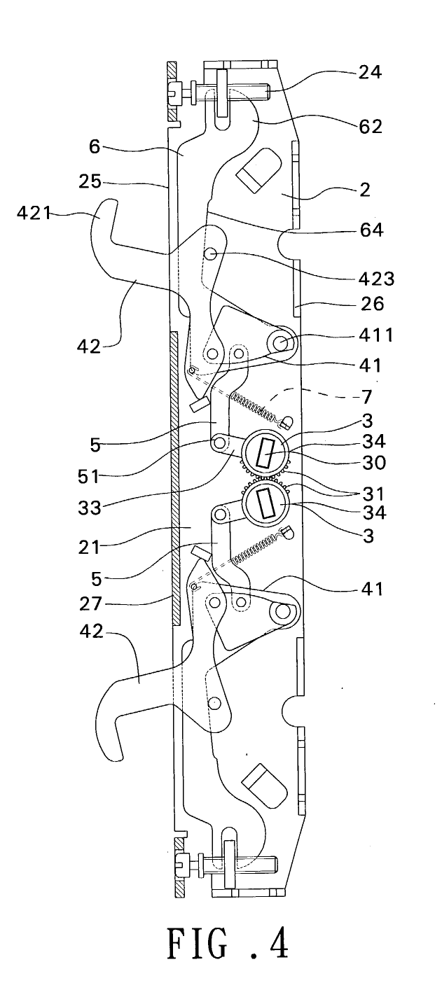

When either of the pivotable members 3 is driven by a shank (not shown) of a handle (not shown) or an actuating plate (not shown) of a lock core (not shown), the other pivotal member 3 is also driven due to the arrangement of the toothed portion 31 on each pivotal member 3. Each hook member 42 is pivoted such that the hooked second end 421 is moved either to the retraced position shown in FIG. 3 or to the extended position shown in FIG. 5. In particular, when a user is intended to switch the lock assembly from the unlocked state shown in FIG. 3 to the locking state shown in FIG. 5, when either pivotal member 3 is turned, the respective linking rod 5 is pivoted to cause pivotal movement of the respective rocker arm 41 and the respective hook member 42 until the peg 423 of the respective hook member 42 abuts against an inner edge 64 of the respective guide plate 6 that faces away from an outer end face 27 of the casing 2, as shown in FIG. 4. The respective spring 7 biases the hooked second end 421 of the respective hook member 42 to a protruded position shown in FIG. 4, as inward movement of the hooked second end 421 of the respective hook member 42 would stretch the respective spring 7. Further rotation of the respective pivotal member 3 causes further pivotal movement of the respective rocker arm 41 and the respective hook member 42, in which the peg 423 of the respective rocker arm 41 moves along the inner edge 64 of the respective guide plate 6 until the respective rocker arm 41 is stopped by a stop 26 of the casing 2. Again, the respective spring 7 biases the hooked second end 421 of the respective hook member 42 to a protruded position shown in FIG. 4. The openings 25 of the casing 2 allow passage of the hooked second ends 421 of the hook members 42. Thus, it takes a burglar longer to destroy the lock assembly in accordance with the present invention.

The respective linking rod 5 is located between the respective pivotable member 3 and the outer end face 27 of the casing 2. It is noted that the respective linking rod 5 does not move beyond the innermost point 34 of the respective pivotable member 3 during its pivotal movement. Thus, the protruded portion 10 (FIG. 1) required in the prior art lock assembly is omitted. The overall thickness of the casing 2 is shorter than that of the conventional design. This allows easy installation of the lock assembly to doors of various mounting hole sizes. Preferably, the pivotable members 3 are aligned along a vertical axis.

Although the invention has been explained in relation to its preferred embodiment, it is to be understood that many other possible modifications and variations can be made without departing from the scope of the invention as hereinafter claimed.

What is claimed is:

1. A lock assembly comprising:
a casing having two openings;
two pivotable members pivotally mounted in the casing, the pivotable members being so configured that rotation of one of the pivotable members causes rotation of the other pivotable member;
two linking rods each having a first end pivotally connected to an associated one of the pivotable members and a second end; and
two hook devices each including a hook member and a rocker arm, each said rocker arm being pivotally mounted in the casing, the second end of each said linking rod being pivotally connected to an associated one of the rocker arms, each said hook member having a first end pivotally connected to an associated one of the rocker arms, each said hook member further including a hooked second end that is passable through an associated one of the openings of the casing;
wherein when either of the pivotable members is pivoted, each said rocker arm and each said hook member are pivoted such that the hooked second end of each said hook member is moved between a retracted position in the casing and an extended position out of the casing.

2. The lock assembly as claimed in claim 1, wherein the casing consists of two casing halves.

3. The lock assembly as claimed in claim 1, further including two guide plates, each said guide plate including a first end pivotally connected to an associated one of the rocker arms, each said follower plate further including an inner edge facing away from an outer end face of the casing, each said rocker arm having a peg that moves along the inner edge of an associated one of the guide plates during a portion of a pivotal movement of said rocker arm.

4. The lock assembly as claimed in claim 1, wherein the pivotable members are aligned along a vertical axis.

5. The lock assembly as claimed in claim 1, wherein each said linking rod is located between an associated one of the pivotable members and an outer end face of the casing.

6. The lock assembly as claimed in claim 5, wherein each said linking rod does not move beyond an innermost point of an associated one of the pivotable members during a pivotal movement of each said linking rod.
